(19) United States
(12) Patent Application Publication
(10) Pub. No.: US 2018/0235244 A1
(43) Pub. Date: Aug. 23, 2018

(54) GLUTEN-FREE NUTRITIONALLY-BALANCED SOLID FOODSTUFF AND METHOD OF MAKING AND USES THEREOF

(71) Applicant: NOURICH FOODS LLC, Primos, PA (US)

(72) Inventor: Benjamin Nielsen, Primos, PA (US)

(73) Assignee: NOURICH FOODS LLC, Primos, PA (US)

(21) Appl. No.: 15/902,115

(22) Filed: Feb. 22, 2018

Related U.S. Application Data
(60) Provisional application No. 62/461,937, filed on Feb. 22, 2017.

(51) Int. Cl. A21D 13/066; A21D 13/047; A21D 2/26; A21D 2/16

(52) U.S. Cl. CPC A21D 13/066; A21D 13/047; A21D 2/165; A21D 2/266; A21D 2/265

(57) ABSTRACT

Nutritionally-balanced gluten-free solid foodstuff that provides carbohydrates, one or more plant-derived proteins having PDCAAS of 0.95, or greater, and lipids in an amount equal to 100% of the Daily Reference Values (DRV) based on the reference caloric intake of 2000 calories, is described. The methods of manufacturing the disclosed gluten-free nutritionally-balanced solid foodstuff are provided.

### CROSS REFERENCE TO RELATED APPLICATIONS

This application claims the benefit of U.S. Provisional Application No. 62/461,937, filed Feb. 22, 2017, which is incorporated by reference as if fully set forth.

### FIELD OF INVENTION

This disclosure relates to nutritionally-balanced gluten-free solid foodstuff that provides carbohydrates, one or more plant-derived proteins having Protein Digestibility Corrected Amino Acid Score (PDCAAS) of 0.95, or greater, and lipids in an amount equal to 100% of the Daily Reference Values (DRV) based on the reference caloric intake of 2000 calories recommended by the U.S. Food and Drug Administration (FDA). The disclosure also relates to methods of making and using the same.

### BACKGROUND

Nutritionists recommend consumers healthy eating habits and nutritionally-balanced diets. Many diets and meals are available for consumers to satisfy their specific needs, i.e., to lose or gain weight, stay healthy, stay vegetarian, or pursue specific diets based on medical needs. These diets include liquid-based meals, and/or solid meals, such as snack bars, and are often intended for consumers' intake on a daily basis. However, the meals are often focused on needs of a particular group of consumers and include ingredients suitable only for this group. Additionally, there are reported problems associated with consumption of liquid-based meals and/or snack bars. Commonly reported problems with available liquid-based meals include bland taste, no flavor options, no solid food options, and the exclusion of people with food allergies or restricted diets. While snack bars are purchased in high numbers, and often used by consumers as meal replacements, these snack bars are neither nutritionally complete nor nutritionally balanced. Most snack bars contain gluten, non-organic, genetically modified ingredients, preservatives, copious amounts of sugar, artificial sweeteners and/or other ingredients deemed undesirable by health conscious consumers. Additionally, snack bars are not intended to fully replace meals, and they do not adequately satisfy hunger if consumed as a meal. Most liquid-based meals and snack bars also do not satisfy nutritional guidelines of the Food and Drug Administration (FDA).

### SUMMARY

In an aspect, the invention relates to a nutritionally-balanced solid foodstuff. The nutritionally-balanced solid food foodstuff comprises carbohydrates, one or more plant-derived proteins and lipids in an amount equal to 100% of the Daily Reference Values (DRV) based on the reference caloric intake of 2000 calories. The one or more plant-derived proteins included in the foodstuff have a Protein Digestibility Corrected Amino Acid Score (PDCAAS) of 0.95 or greater.

In an aspect, the invention relates to a method of manufacturing a nutritionally-balanced solid product. The method comprises selecting components of the foodstuff comprising carbohydrates, one or more plant-derived proteins having PDCAAS of 95 or greater, and lipids. The method comprises determining an amount of each one of the components that is equal to 100% of the Daily Reference Values (DRV) for food based on the reference caloric intake of 2000 calories. The method further comprises preparing dough by combining the food components. The method also comprises applying to the dough at least one process selected from the group consisting of: baking, crumbing, injecting with inert gas, and extruding.

### BRIEF DESCRIPTION OF THE DRAWING

The following detailed description of embodiments will be better understood when read in conjunction with the appended drawings. For the purpose of illustration, there are shown in the drawings embodiments which are presently preferred. It is understood, however, that the invention is not limited to the precise arrangements and instrumentalities shown. In the drawings:

FIG. 1 is a flowchart illustrating a method of manufacturing a nutritionally-balanced solid foodstuff according to an embodiment disclosed herein.

FIG. 2 shows an exemplary nutrition label for the solid foodstuff.

FIG. 3 is an oil composition chart.

### DETAILED DESCRIPTION OF THE PREFERRED EMBODIMENTS

Certain terminology is used in the following description for convenience only and is not limiting. The words “a” and “one,” as used in the claims and in the corresponding portions of the specification, are defined as including one or more of the referenced item unless specifically stated otherwise. The phrase “at least one” followed by a list of two or more items, such as “A, B, or C,” means any individual one of A, B or C as well as any combination thereof.

As used herein, the term “nutritionally-balanced,” when used in conjunction with the word “foodstuff,” means a reference daily serving or servings of food that provides lipids. protein, and carbohydrates in an amount equal to Daily Reference Values (DRV) set forth by the U.S. Food and Drug Administration (FDA) for a daily intake by a person as defined in 21 C.F.R. 101.9, which is incorporated herein by reference as if fully set forth. The nutritionally-balanced solid foodstuff may be used as a single source of food for a daily intake, and may be provided as a plurality of units, for example, as a bag or bags of biscuits, bars, cookies, crisps, chips, crackers, puffed snacks, or extruded snacks or brownies to be consumed per day.

As used herein, the term “lipids” refers to the group of naturally occurring molecules that include fats, waxes, sterols, fat-soluble vitamins, such as vitamins A, D, E, and K, monoglycerides, diglycerides, triglycerides, cholesterol, and phospholipids. The terms “lipids,” “fat,” and “oil” are used as synonyms herein.

An embodiment provides a nutritionally-balanced solid foodstuff comprising food components in quantities equal to 100% of the Daily Reference Values (DRV) of food based on the reference caloric intake of 2000 calories. As used herein, the Daily Reference Values are based on the guidelines established by the U.S. Food and Drug Administration. Federal Register, vol. 81, No. 103, May 27, 2016.

The DRV set forth by the FDA in 1990 and 2016 are shown in Table 1.

TABLE 1
Daily Reference Values (DRV)

| Food component | Unit of measurement | DRV* | DRV** |
|---|---|---|---|
| Fat | Grams (g) | 65 | 78 |
| Saturated fat | Grams (g) | 20 | 20 |
| Cholesterol | Milligrams (mg) | 300 | 300 |
| Total carbohydrate | Grams (g) | 300 | 275 |
| Dietary fiber | Grams (g) | 25 | 28 |
| Sodium | milligrams (mg) | 2,400 | 2,300 |
| Protein | grams (g) | 50 | 50 |

*21 C.F.R. §101.9 (2015, adheres to 1990 guidelines)
**Federal Register, Vol. 81, No. 103, May 27, 2016; 21 C.F.R. §101.9

The food components may comprise one or more plant-derived proteins, carbohydrates and lipids. The foodstuff may also include one or more additional food components. The one or more additional food components may be, minerals and vitamins

The plant-derived protein or a combination of plant-derived proteins may be a protein or proteins that have a PDCAAS value of 0.8-1.00, or any integer value therebetween, or in a range between any two integer values therebetween. The plant-derived protein or the combination of plant-derived proteins may have a PDCAAS value of 0.80, 0.81, 0.82, 0.83, 0.84, 085, 0.86, 087, 0.88, 0.89, 0.90, 0.91, 0.92, 0.93, 0.94, 0.95, 0.96, 0.97, 0.98, 0.99 or 1.0. The plant-derived protein or the combination of plant-derived proteins may have the PDCAAS value of 0.8 to 0.85, 0.85 to 0.90, 0.90 to 0.95, or 0.95 to 1.0, or any integer value therebetween, or in a range between any two integer values therebetween. The plant-derived protein or the combination of plant-derived proteins may have the PDCAAS value of 0.85 to 0.98, or any integer value therebetween, or in a range between any two integer values therebetween. The plant-derived protein or the combination of plant-derived proteins may have the PDCAAS value of 0.89 to 0.96, or any integer value therebetween, or in a range between any two integer values therebetween. The plant-derived protein or the combination of the plant-derived proteins may have the PDCAAS value of 1.0. As used herein, PDCAAS is a method of evaluating the protein quality based on both the amino acid requirements of humans and their ability to digest it. PDCAAS was adopted by the Food and Drug Administration (FDA) and the Food and Agricultural Organization of the United Nations/World Health Organization (FAO/WHO) in 1993 as “the preferred ‘best” method to determine protein quality. A PDCAAS value of 1.00 is the highest, and 0 the lowest. The plant derived protein may be a brown rice protein, a yellow pea protein, or any other plant-derived protein, or a combination of plant-derived proteins. It is known that many plant-derived proteins exhibit an incomplete amino acid profile. The combination of plant-derived proteins may be complementary plant-derived proteins that can produce a combined amino acid profile that meets the needs of the average person. The combination of plant derived-proteins may be a combination of a brown rice protein and a yellow pea protein. The combination of the brown rice protein and the yellow pea protein has a PDCAAS value of 1.00.

The nutritionally-balanced foodstuff may comprise carbohydrates. As used herein, the term “carbohydrates” refers to a group of compounds that includes sugars, including monosaccharides, disaccharides, oligosaccharides, and polysaccharides, starch, and cellulose. The carbohydrates of the foodstuff described herein may derive from plants. The plant-derived carbohydrates may include plant flour. The plant flour may be any plant flour free of gluten. The plant flour may be white rice flour. The plant flour may be sorghum flour. The plant flour free of gluten may be any plant flour that satisfies the requirement of Gluten Free Certification Organization to contain 10 ppm or less of gluten per foodstuff.

The carbohydrates may comprise dietary fiber. As used herein, the term “dietary fiber” refers to plant-derived food components that are not digested and/or absorbed in the human digestive system. Dietary fiber may include cellulose, hemicellulose, pectin, or beta-glucan soluble fiber, or a combination thereof. Dietary fiber may be water-soluble dietary fiber, for example, pectin or beta-glucan. Dietary fiber may be insoluble dietary fiber, for example, cellulose.

The nutritionally-balanced foodstuff may comprise dietary fiber that includes ½ soluble fiber and ½ insoluble fiber. Because the daily reference values for fiber is 25 g according to the 1990 regulation, or 28 g according to the 2016 regulation, the foodstuff may include 12.5 g of each of soluble and insoluble fiber of 25 g total dietary fiber per 1990 guidelines, or 14 g of each of soluble and insoluble fiber of 28 g total dietary fiber per 2016 guidelines. The soluble fiber may be a psyllium husk powder.

The dietary fiber included in the foodstuff may also function as a binding agent. Due to the lack of gluten in the plant flour, the dough for preparing the foodstuff would have had practically no viscoelasticity, and would crumble or break apart rather than stretching out when attempting to pull it apart. To prevent crumbling and tearing during dough handling, the foodstuff may incorporate an ingredient that would provide the dough with some elasticity. The ingredient may be an ingredient having properties that allow the ingredient to create a gel when introduced to water and improve viscoelasticity when incorporated into other ingredients. The ingredient may be a hydrocolloid. The hydrocolloid may be a naturally occurring hydrocolloid. The hydrocolloid may be starch, cereal-based beta glucan, or konjac mannan. The hydrocolloid may be psyllium husk.

The carbohydrates may include honey as the source of sugars. Honey is a sweet, viscous food substance produced by bees. Honey is a well-accepted sweetener among consumers, and is a source of simple sugars, fructose and glucose. Honey acts as an emulsifier due to its amphiphilic nature. Thus, one end of the molecules in honey are attracted to water (hydrophilic), while the other end of those molecules are attracted to fats or lipids (lipophilic)(Laura Cassidy, “Emulsions: making oil and water mix,” The American Oil Chemists' Society, 2016, available at https://www.aocs.org/stay-informed/read-inform/featured-articles/emulsions-making-oil-and-water-mix-april-2014).

Additionally, honey is not only amphiphilic in nature, it is also a humectant. Humectants absorb free water, i.e., water that is not bonded to other molecular structures, thus reducing the water activity level of the food. Water activity is important in foods intended on having a long shelf life, especially, if there are no artificial preservatives. Because honey serves for the purpose of an emulsifier and a humectant, honey may be a preferred source of sugars in the foodstuff. Although honey serves as a preferred source of sweetener in the foodstuff, it was determined that the palatability of the product may be enhanced by slightly increasing the sweetness.

In an embodiment, the foodstuff may include a sweetener. The sweetener may be a neutral sweetener that improves taste of the foodstuff. The sweetener may be a natural sweetener. The natural sweeteners may be a nutritive sweetener, or a sweetener that provides caloric intake. The nutritive natural sweetener may be honey. The natural sweetener may be a non-nutritive natural sweetener, or a sweetener that contains zero or few calories. The natural sweetener may derive from a plant species in the genus Stevia. The natural sweetener may be a sweetener or sugar substitute extracted from the leaves of the plant species Stevia rebaudiana. The stevia extract may be used in the form of steviol glycosides or rebaudiosides. The stevia may be used in any other form. The stevia extract may be used as a natural extract. The stevia extract may be used in the form of a commercially available product. The stevia extract may be used in the form of “rebaudioside M.” The natural non-nutritive sweetener may be a monk fruit, also known as Lo Han Guo. The monk fruit may be used in the form of a monk fruit extract. The natural non-nutritive sweetener may be any other natural non-nutritive sweetener.

The natural sweetener may be also used as an emulsifier during preparation of the foodstuff. As used herein, an emulsifier is an ingredient that is used in a recipe for making a fairly homogeneous product, and is used to emulsify the oil and water in the recipe. Without an emulsifier, the oil and/or water can coalesce either during the dough creation, or even after baking the product. The honey used as a natural sweetener may be used as an emulsifier due to its amphiphilic nature. As used herein, “amphiphilic nature” means that one end of the molecules in honey are attracted to water (hydrophilic), while the other end of those molecules are attracted to fats or lipids (lipophilic). Furthermore, artificial sweeteners and refined sugars such as sucrose had gained a bad reputation among dietitians, nutritionists, as well as consumers who made it a priority to have a healthy lifestyle, and thus, may be avoided in the foodstuff.

In an embodiment, the nutritionally-balanced foodstuff may include a flavoring agent. The flavoring agent may be a lemon extract, cinnamon powder, or ginger powder. To enhance the palatability of the foodstuff, the flavoring agents may be used individually or in a combination to flavor the dough. The use of a flavoring agent may or may not impact the nutritional profile of the foodstuff. The use of lemon extract may not impact the nutritional profile of the foodstuff. However, utilizing cinnamon and ginger may have an impact the micro-nutrient profile. The foodstuff may include a flavor enhancer. The flavor enhancer may be salt. Salt may contribute to the nutritional completeness of the foodstuff as a source of sodium, and also enhance the flavor, and therefore, the palatability of the foodstuff.

The nutritionally-balanced foodstuff may comprise lipids. The lipids may be in the form of oil derived from a plant or plants. The plant-derived oil may be any plant oil with reduced level of saturated fat. The professional health organizations, e.g., American Heart Society, has proposed guidelines stating that the percent of total caloric intake from fat be reduced to 30% or less. The plant-derived oil included in the foodstuff may be oil that contributes 15%, or less, of caloric intake from saturated fat. The plant-derived oil may be any oil that includes high level of polyunsaturated fats that are a source of essential fatty acids, for example, omega-3 and omega-6 fatty acids. The plant-derived oil may include polyunsaturated fats in the amount of 10% (v/v), or greater, of the plant-derived oil. The plant-derived oil may be grapeseed oil. The grapeseed oil includes saturated fat in the amount of 10% (v/v), monounsaturated fat in the amount of 16% (v/v), and polyunsaturated fat in the amount of 70% (v/v) of the grapeseed oil. The plant-derived oil may be safflower oil. The safflower oil includes saturated fat in the amount of 10% (v/v), monounsaturated fat in the amount of 13% (v/v), and polyunsaturated fat in the amount of 77% (v/v) of the grapeseed oil. The plant-derived oil may be linoleic sunflower oil. The linoleic sunflower oil includes saturated fat in the amount of 11% (v/v), monounsaturated fat in the amount of 20% (v/v), and polyunsaturated fat in the amount of 69% (v/v) of the grapeseed oil.

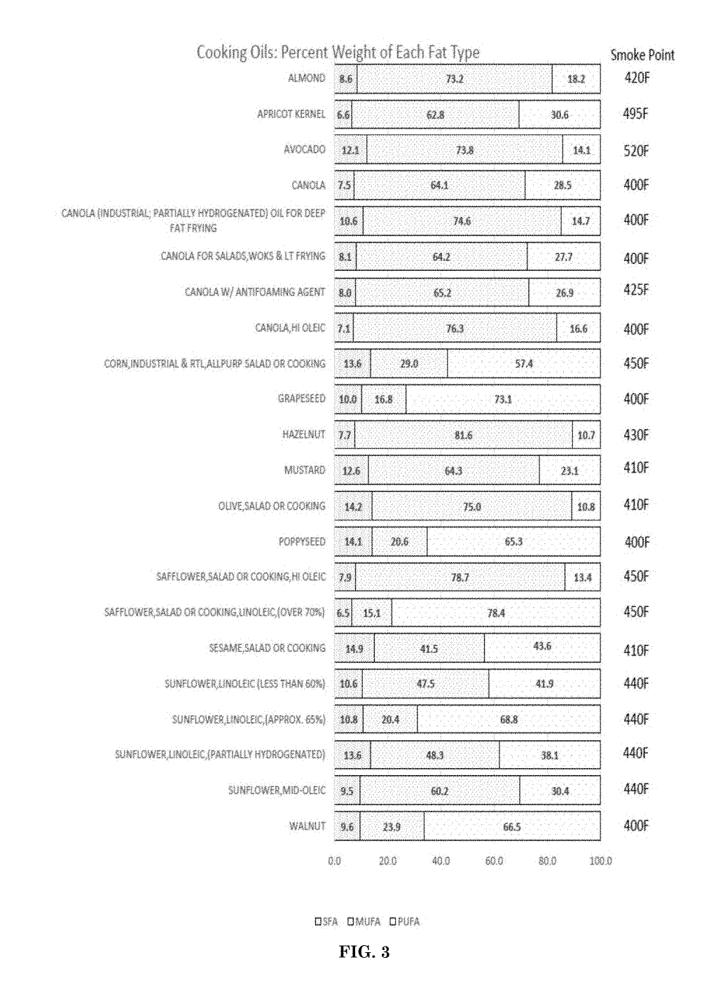

The typical temperature for baked goods is 350° F. The plant derived-oil may be any oil having a smoke point of at 350° F., or higher. The plant-derived oil may be any single oil, or a combination of oils. The plant derived oil may be any oil listed in the chart illustrated in FIG. 3. The plant-derived oil may be, but is not limited to, grapeseed oil having a smoke point of 399° F., linoleic sunflower oil having a smoke point of 475° F., or safflower oil having a smoke point of 490-510° F., sesame oil having the smoke point 410° F. The plant derived-oil may be grapeseed oil having a high smoke point of 399° F.

In an embodiment, the nutritionally-balanced foodstuff may include one or more additional food components. The one or more additional food components may be minerals and vitamins. The vitamins may be, but are not limited to, vitamin A, vitamin C, vitamin D, vitamin E, vitamin K, thiamin, riboflavin, niacin, vitamin B6, vitamin B12, folate, biotin, and pantothenic acid. The minerals may be, but are not limited to, calcium, iron, phosphorus, iodine, magnesium, zinc, selenium, copper, manganese, chromium, molybdenum, chloride, potassium, and choline. The vitamins and minerals may be provided in quantities shown in Table 2 and may be equal 100% of the FDA recommended daily reference values for all micronutrients and vitamins on a 2,000 calories per day basis with a tolerance level of ±5% shown in Table 2.

TABLE 2
Reference Daily Intake of Vitamins and Minerals*

| | | Adult and |
|---|---|---|
| | | children > 4 |
| Nutrient | Unit of Measure | years |
| Vitamin A | Micrograms RAE¹ (mcg) | 900 |
| Vitamin C | Milligrams (mg) | 90 |
| Calcium | Milligrams (mg) | 1,300 |
| Iron | Milligrams (mg) | 18 |
| Vitamin D | Micrograms (mcg) | 20 |
| Vitamin E | Milligrams (mg) | 15 |
| Vitamin K | Micrograms (mcg) | 120 |
| Thiamin | Milligrams (mg) | 1.2 |
| Riboflavin | Milligrams (mg) | 1.3 |
| Niacin | Milligrams NE² (mg) | 16 |
| Vitamin B6 | Milligrams (mg) | 2.4 |
| Folate | Micrograms DFE³ (mcg) | 400 |
| Vitamin B12 | Micrograms (mcg) | 2.4 |
| Biotin | Micrograms (mcg) | 30 |
| Pantothenic acid | Milligrams (mg) | 5 |
| Phosphorus | Milligrams (mg) | 1,250 |
| Iodine | Micrograms (mcg) | 150 |
| Magnesium | Milligrams (mg) | 420 |
| Zinc | Milligrams (mg) | 11 |
| Selenium | Micrograms (mcg) | 55 |
| Copper | Milligrams (mg) | 0.9 |
| Manganese | Milligrams (mg) | 2.3 |
| Chromium | Micrograms (mcg) | 35 |
| Molybdenum | Micrograms (mcg) | 45 |
| Chloride | Milligrams (mg) | 2,300 |
| Potassium | Milligrams (mg) | 4,700 |
| Choline | Milligrams (mg) | 550 |
| Protein | Grams (g) | NA |

*21 C.F.R. §101.9 (revised 2017)
¹RAE—retinol activity equivalents; 1 microgram RAE - 1 microgram retinol, 2 microgram supplemental β-carotene, 12 micrograms β-carotene, or 24 micrograms α-carotene, or 24 micrograms β-cryptoxanthin.
²NE—Niacin equivalents, 1 mg NE = 1 mg niacin = 60 milligrams tryptophan.
³DFE = Dietary folate equivalents; 1 DFE = 1 mcg naturally-occurring folate = 0.6 mcg folic acid.

In an embodiment, the nutritionally-balanced foodstuff may be prepared in any form. The foodstuff may be in the form of a biscuit, a bar, a cookie, a crisp (thin, wafer-like product), a pellet, a patty, a cake, a chip, a cracker, a puffed snack, extruded snack or brownie.

The nutritionally-balanced foodstuff may provide 702 fat calories, 1200 carbohydrate calories, and 200 protein calories out of a 2,000 calorie per day diet. The foodstuff may include carbohydrates in the amount of 52.6-53.9% (w/w) (or any integer value therebetween, or in a range between any two integer values therebetween) of the foodstuff. The foodstuff may include carbohydrates in the amount of 52.6, 52.7%, 52.8, 52.9, 53.0, 53.1, 53.2, 53.3, 53.4, 53.5, 53.6, 53.7, 53.8 or 53.9% (w/w) (or any integer value therebetween, or in a range between any two integer values therebetween) of the foodstuff. The foodstuff may include proteins in the amount of 10.2-10.5% (w/w) (or any integer value therebetween, or in a range between any two integer values therebetween) of the foodstuff. The foodstuff may include proteins in the amount of 10.2, 10.3, 10.4, or 10.5% (w/w) (or any integer value therebetween, or in a range between any two integer values therebetween) of the foodstuff. The foodstuff may include fat in the amount of 35.9-36.9% (w/w) (or any integer value therebetween, or in a range between any two integer values therebetween) of the foodstuff. The foodstuff may include fat in the amount of 35.9, 36.0, 36.1, 36.2, 36.3, 36.4, 36.5, 36.6, 36.7, 36.8 or 36.9% (w/w) (or any integer value therebetween, or in a range between any two integer values therebetween) of the foodstuff. The proportion of calories contributed by fat and protein may depend on the amount of soluble fiber used in the foodstuff as described in the Examples section entitled “Calculating caloric and macronutrient content of the foodstuff.”

A non-limiting example of the total caloric value of the ingredients included in the foodstuff is provided in Table 3.

TABLE 3
Total caloric value of a nutritionally-balanced solid foodstuff

| Ingredient/100 kcal | Amount |
|---|---|
| Carbohydrates (g) | 13.75-15 |
| Lipids (g) | 3.25-3.9 |
| Saturated fat (g) | <1 |
| Proteins (g) | 2.5 |
| Dietary Fiber (g) | 1.25-1.4 |
| Carbohydrates (%) | 52.6-53.9 |
| Lipids (%) | 35.9-36.9 |
| Proteins (%) | 10.2-10.5 |

In an embodiment, the nutritionally balanced foodstuff may include 13.75 g to 15 g carbohydrates, 3.2 g to 3.9 g lipids, less than 1 g saturated fat, 2.5 g proteins, 1.25 g to 1.4 g dietary fiber, or 52.6 to 53.9% carbohydrates, 35.9 to 36.9% lipids and 10.2 to 10.5% proteins per 100 kcal of the foodstuff in accordance with the amounts shown in Table 3. The foodstuff may include from 13.75 g to 13.80 g of carbohydrates, from 13.75 g to 13.85 g of carbohydrates, from 13.75 g to 13.90 g of carbohydrates, from 13.75 g to 13.95 g of carbohydrates, 13.75 g to 14.00 g of carbohydrates, from 13.75 g to 14.25 g of carbohydrates, from 13.75 g to 14.50 g of carbohydrates, from 13.75 g to 14.75 g of carbohydrates, or from 13.75 g of carbohydrates to 15.00 g of carbohydrates (or any integer value therebetween, or in a range between any two integer values therebetween) per 100 kcalories of the foodstuff. The foodstuff may include from 3.2 g to 3.9 g of lipids, from 3.2 g to 3.8 g of lipids, from 3.2 g to 3.7 g of lipids, from 3.2 g to 3.6 g of lipids, from 3.2 g to 3.5 g of lipids, from 3.2 g to 3.4 g of lipids, or from 3.2 g to 3.3 g of lipids (or any integer value therebetween, or in a range between any two integer values therebetween) per 100 kcalories of the foodstuff. The foodstuff may have less than 1.0 g of saturated fat. The foodstuff may have 0.9 g, 0.8 g, 0.7 g, 0.6 g, 0.5 g, 0.4 g, 0.3 g, 0.2 g, 0.1 g or 0 g (or any integer value therebetween, or in a range between any two integer values therebetween) of saturated fat per 100 kcalories of the foodstuff. the foodstuff may include from 1.25 g to 1.4 g of dietary fiber, from 1.25 g to 1.35 g of dietary fiber, or from 1.25 g to 1.3 g of dietary fiber (or any integer value therebetween, or in a range between any two integer values therebetween) per 100 kcalories of the foodstuff.

In an embodiment, the nutritionally-balanced foodstuff may have sufficient thickness and diameter to represent an exact caloric quantity of the foodstuff. The exact caloric quantity may be greater or equal to 5 calories and lesser or equal to 10 calories per “unit” of the foodstuff. The exact caloric quantity may be 5, 6, 7, 8, 9 or 10 calories per “unit” of the foodstuff. The “unit” of the foodstuff may be a biscuit, a bar, a cookie, a crisp, a pellet, a patty, a cake, a chip, a cracker, a puffed snack, or extruded snack or brownie.

In an embodiment, the nutritionally-balanced foodstuff may have a water activity level of 0.20 to 0.30, 0.20 to 0.29, 0.20 to 0.28, 0.20 to 0.27, 0.20 to 0.26, 0.20 to 0.25, 0.20 to 0.24, 0.20 to 0.23, 0.20 to 0.22, or 0.20 to 0.23, or any integer value therebetween, or in a range between any two integer values therebetween. The foodstuff may have water activity levels of 0.250, 0.251, 0.252, 0.253, 0.254, 0.255, 0.256, 0.257, 0.258, 0.259, or 0.260, or any integer value therebetween, or in a range between any two integer values therebetween As used herein, the foodstuff having a water activity level of less than 0.30 is considered anhydrous. The foodstuff may have a water activity level sufficient to reduce lipid oxidation and browning reactions. The foodstuff may have a water activity level sufficient for the product to have a shelf life of one year, two years, three years, or longer.

In an embodiment, a method of preparing a nutritionally-balanced solid foodstuff is provided. The method may include combining plant flour with one or more plant-derived proteins and plant-derived oil to prepare dough. The method may include adding other food ingredients described herein to the dough.

In an embodiment, a method of manufacturing any one of the nutritionally-balanced solid foodstuff described herein is provided.

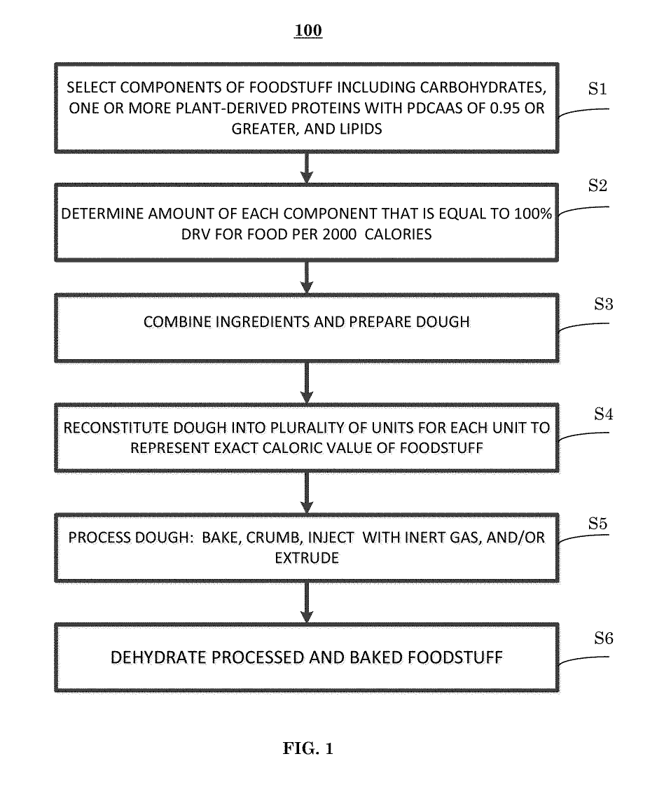

FIG. 1 is a flow chart of the steps of an exemplary method manufacturing of any one of the nutritionally-balanced solid foodstuff described herein. As illustrated in FIG. 1, the method 100 may comprise the step S1 of selecting components of the foodstuff. The components may comprise any one of the carbohydrates, one or more plant-derived proteins having PDCAAS of 95, or greater, and lipids, described herein.

The step S2 of the method comprises determining an amount of each one of the components that is equal to 100% of the Daily Reference Values (DRV) for food based on the reference caloric intake of 2000 calories using the following equation (1):

x=A⁻¹b,

wherein ‘x’ is a reference multiplier of the ingredient used in the recipe, ‘A’ is an amount of the component of the ingredient, ‘b’ is a target caloric value contributed by the component of the ingredient per a 100 g reference. For multiple ingredients, equation (1) may be presented in matrix as described in the Examples section entitled “Calculating caloric and macronutrient content of the foodstuff” herein.

In step S3, components of the foodstuff may be combined to prepare dough.

In step S4, the dough may be reconstituted into a plurality of units. Typically, each unit of the plurality of units represents an exact caloric value of the foodstuff. For example, the exact caloric value of the unit may be equal 5 grams of calories or greater, or 10 grams of calories or lesser per unit of the foodstuff.

In step S5, the dough prepared in step S4 may be subjected to any one of the following processes. The dough may be baked in a convection oven. The dough may be baked in a convection oven. The dough may be baked in a convection oven, and then crumbed. The dough may be injected with inert gas to create a puffed snack that is then baked. The dough may be extruded and then baked in a convection oven. The dough may be extruded and then baked in a convection oven.

In step S6, the baked and processed dough may be dehydrated. Typically, the dough may be dehydrated to have a water activity level of 0.30, or less. The method may further comprise storing the anhydrous foodstuff for a period of time. The foodstuff may be stored for a year, two years, three years, or longer.

Further embodiments herein may be formed by supplementing an embodiment with one or more element from any one or more other embodiment herein, and/or substituting one or more element from one embodiment with one or more element from one or more other embodiment herein.

### Examples

The following non-limiting examples are provided to illustrate particular embodiments. The embodiments throughout may be supplemented with one or more detail from one or more example below, and/or one or more element from an embodiment may be substituted with one or more detail from one or more example below

A purpose of the foodstuff described herein is to provide 100% of the FDA recommended daily values for all macro- and micro-nutrients (on a 2,000 kcal/day basis). It was determined that to be more appealing to consumers, the foodstuff should be able to make any and all of the “clean label claims” that have exhibited increasing popularity over recent years. Such “clean label claims” include, without limitation, USDA Organic, non-GMO, free of the 8 main food allergens (including wheat (gluten), soy, milk-based products, eggs, tree nuts, and peanuts) as well as being free of artificial colors, flavors, and preservatives. Furthermore, the foodstuff is preferably vegan, as well as having it Kosher and halal certified.

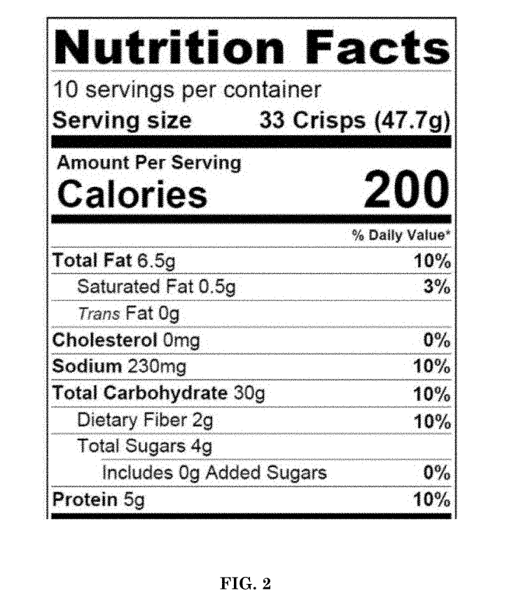

The foodstuff preferably has a shelf life of one year or more, which makes it appealable to consumer segments such as military and organizations such as disaster relief and foreign aid organizations. FIG. 2 shows an exemplary nutrition label for the foodstuff described herein.

Several different recipe formulations are presented herein so this foodstuff could be created that would satisfy the FDA's guidelines at different times.

A preferred embodiment of the foodstuff described herein includes a source of flour, at least one source of protein, a source of fat, an emulsifier, and a binding agent, and optionally includes any one or more of a sweetener and flavor enhancer.

Ingredients Used in Recipe

1. Flour: White Rice Flour

Flour is the basis for a majority of baked goods as it is the primary contributor of carbohydrates. In many cases, gluten with flour holds dough together. Since a primary objective of the present foodstuff is to make a product that is palatable to as wide an array as possible, one of the critical factors in determining flour type was is to appeal to those with gluten allergies. This entails elimination of wheat and rye flours, the latter because it often includes some quantity of wheat flour, including gluten.

Although there is a long list of non-gluten flours, many options are not commercially practical because of either (a) high costs relative to other flours that are easier to produce (or more abundant), and (b) the potential for problems with other allergies (peanuts/tree nuts) or dietary restrictions (such as foods that are available as non-GMO). Furthermore, another objective of the foodstuff is for it to be suitable in foreign aid situations such as disaster relief or to be donated to countries where food insecurity is rampant. As a result, it was determined that the flour should be derived from a staple crop that could be readily available to many markets. In a preferred embodiment, white rice flour or sorghum flour was selected as a source of flour.

2. Protein Source 1: Brown Rice Protein

In order to develop a balanced foodstuff that can provide 100% of the FDA recommended daily values for all nutrients, it was determined that refined protein sources would greatly facilitate the balancing and incremental adjustments necessary to achieve that objective. In addition, because the foodstuff is vegan-friendly, no animal-based protein sources can be used.

In keeping with the concept to use staple crop sources for ingredients as described above, in a preferred embodiment, brown rice protein was selected as a protein source. Like many plant-based proteins, brown rice protein often exhibits an incomplete amino acid profile. Therefore, in a preferred embodiment, the foodstuff uses two or more complementary plant-based proteins to produce a combined amino acid profile that satisfies the dietary needs of the average person. This is signified by the PDCAAS (protein digestibility-corrected amino acid score) value of 1.00 for a combination of rice and peas. (Day, L., “Proteins from Land Plants—Potential Resources for Human Nutrition and Food Security,” Trends in Food Science & Technology, 32: Pp. 34-35 (2013)).

Protein Source 2: Yellow Pea Protein

Yellow pea protein is a preferred second protein source because it has an amino acid profile that is complementary to brown rice protein and is a plant-based protein source. Individually, brown rice protein and yellow pea protein do not provide a sufficient amino acid profile, however, together they complement each other to deliver an adequate amino acid profile.

Other plant-derived proteins can be used in the foodstuff. Pea, rice and ancient grains are acceptable sources of the proteins. (Euromonitor International (Passport). Global Trends in Protein—Global Briefing. 23 Mar. 2016. Slide 25). Soy protein has PDCAAS value of 0.9, and protein derived from organically grown soybeans can be used in the foodstuff described herein.

3. Fat Source: Grapeseed Oil

It is fairly well known foodstuff that saturated fat is harmful to one's health. However, the benefits and/or drawbacks of mono-unsaturated fats and poly-unsaturated fats are typically not as well known. Although mono-unsaturated fats and poly-unsaturated fats reduce LDL (low density lipid) levels, there is evidence to suggest that mono-unsaturated fats increase HDL (high density lipid) levels. However, poly-unsaturated fats include two types of essential fatty acids that cannot be synthesized in the body using other fat sources: (1) omega-3 fatty acids; and (2) omega-6 fatty acids.

In addition to cost factors, a goal in choosing a primary source of fat is to reduce the saturated fat content as much as possible. Another goal is to select a source with a large proportion of poly-unsaturated fat relative to mono-unsaturated fat.

A relatively comprehensive list of commonly available oils can be found in FIG. 3, and was used as a primary guide in selecting oils for use in the foodstuff described herein. The selection of the preferred oil, grapeseed oil, was based because of the low content of saturated fat, and high level of poly-unsaturated fat. Other oils listed in FIG. 3 can be used in the foodstuff. The typical temperature for baked goods is 350° F. The preferred grapeseed oil was selected because of its high smoke point of 399° F. In addition, because grapeseed oil is largely a byproduct of the wine industry, its cost will likely continue to decrease as the trend in wine consumption increases. Other plant-derived oils having properties similar to the properties of grapeseed oil can be used in the foodstuff. For example, linoleic sunflower oil, sesame oil, safflower oil can be used.

4. Sweetener and Emulsifier: Honey

It was determined that adding nutritionally neutral sweetener to improve taste was possible without necessarily increasing the nutrient profile. An objective of the foodstuff described herein was to create a sweet product while also avoiding artificial sweeteners and refined sugars, such as sucrose. In addition, in order to have a fairly homogeneous product it is necessary to emulsify the oil and water in the recipe. Without an emulsifier, the oil and/or water can coalesce either during the dough creation, or even after baking the product.

Honey is a well-accepted sweetener among consumers, and is a source of simple sugars. Honey acts as an emulsifier due to its amphiphilic nature. Thus, one end of the molecules in honey are attracted to water (hydrophilic), while the other end of those molecules are attracted to fats or lipids (lipophilic)(Laura Cassidy, “Emulsions: making oil and water mix,” The American Oil Chemists' Society, 2016, available at https://www.aocs.org/stay-informed/read-inform/featured-articles/emulsions-making-oil-and-water-mix-april-2014).

Additionally, honey is not only amphiphilic in nature, it is also a humectant. Humectants absorb free water, i.e., water that is not bonded to other molecular structures, thus reducing the water activity level of the food. Water activity is important in foods intended on having a long shelf life, especially, if there are no artificial preservatives. The foodstuff described herein can be used in humanitarian daily rations (HDRs) and meals ready-to-eat (MREs). Because honey serves for the purpose of an emulsifier and a humectant, it is an essential ingredient in the recipe.

Although honey serves as a preferred source of sweetener in the foodstuff, it was determined that the palatability of the product could be enhanced by slightly increasing the sweetness. There are many non-calorie sweeteners that are commercially available, however, the US FDA has categorized all of them as “artificial sweeteners,” with the exception of stevia.

Multiple glycosides are extracted from the leaves of Stevia rebaudiana including, but not limited to, steviol, stevioside, steviolbioside and rebaudiosides A, B, D, E, F and M. The commonly used commercial blend of stevia produces an aftertaste in the product that is undesirable to some people (Vaclavik, V. and Christian, E. Essentials of Food Science, 4th Edition. Page 288). However, a stevia extract known as “rebaudioside M” has exhibited a very well-rounded sweetness profile with minimal aftertaste in studies. Rebaudioside M is also referred herein as RebM (Blue California, Co., CA). It is believed that this new stevia blend can further improve the taste of the foodstuff. 5. Fiber and Binding Agent: Psyllium Husk Powder

Binding agents are commonly used in dough prepared with flour that lack gluten to improve viscoelasticity of the dough and to prevent it from crumbling and tearing during handling. The foodstuff described herein is prepared with the white rice flour that lacks gluten, and a binding agent to improve viscoelasticity is required. There are many ingredients that can improve viscoelasticity of the dough. Some of these ingredients can create a gel when introduced to water and are known as hydrocolloids. There are many naturally occurring hydrocolloids that can be used in the foodstuff. One of them is psyllium husk that was selected for the foodstuff in a preferred embodiment. Psyllium husk is also a source of dietary fiber. Psyllium husk in the form of psyllium husk powder is incorporated in the foodstuff herein.

6. Flavor Enhancer: Salt

Salt is included in the foodstuff because it contributes to the nutritional completeness of the product as a source of sodium, and also enhances the flavor, and therefore the palatability of the foodstuff.

7. Flavorings:

To enhance the palatability of the foodstuff, two preferred flavorings that can be optionally included in the foodstuff include: lemon and cinnamon-ginger. In an embodiment, the foodstuff is prepared in the form of crisps flavored with lemon. The lemon-flavored crisps utilize lemon extract. In another embodiment, the foodstuff is prepared in the form of crisps flavored with cinnamon and ginger. The cinnamon-ginger flavored crisps use cinnamon and ginger powder to flavor the doughs. It is expected that the use of lemon extract do not impact the nutritional profile of the foodstuff. However, utilizing cinnamon and ginger will likely impact the micro-nutrient profile. An exemplary composition of the foodstuff is illustrated in Table 4.

TABLE 4
Ingredients and Nutritive Content Breakdown of Solid Foodstuff (1990 FDA Guidelines)

| | | B | C | D | E | F | | | | | | |
|---|---|---|---|---|---|---|---|---|---|---|---|---|
| | | White | Brown | Yellow | Psyllum | Grape | | H | | J | | L |
| | A | Rice | Rice | Pea | Husk | Seed | G | Table | I | Cin- | K | Grand |
| 1 | Ingredient | Flour | Protein | Protein | Powder | Oil | Honey | Salt | Reb M | namon | Ginger | Total |
| 2 | Reference amount | 100 g | 100 g | 100 g | 100 g | 100 g | 100 g | 100 g | 100 g | 100 g | 100 g | |
| 3 | Reference | 2.3206 | 0.099 | 0.2771 | 0.205 | 0.622 | 1.067 | 0.0497 | 0.01 | 0.05 | 0.025 | |
| | multiplier* | | | | | | | | | | | |
| 4 | Mass in recipe (g) | 232.063 | 9.229 | 27.708 | 20.504 | 62.285 | 106.69 | 4.975 | 1.000 | 5.000 | 2.500 | 472.60 |
| 5 | Moisture (g) | 12.16 | 3.88 | 0 | 8.613 | 0 | 17.6 | 0.2 | 1.31 | 10.58 | 9.94 | 49.9 |
| 6 | Ash (g) | 0.1 | 1.63 | 4.09 | 2.894 | 0 | 0.24 | 99.8 | 0 | 3.6 | 5.22 | 7.7 |
| 7 | Calories | 365.0 | 365.3 | 382.08 | 227.64 | 884 | 304 | 0 | 395 | 247 | 335 | 1935 |
| 8 | Total fat (g) | 0.66 | 1.34 | 2.2 | 1.571 | 100 | 0 | 0 | 0.03 | 1.24 | 4.24 | 65.0 |
| 9 | Sat. fat (g) | 0.21 | 0.55 | 0.4244 | 0 | 10.04 | 0 | 0 | 0 | 0.649 | 2.75 | 7.0 |
| 10 | Trans fat (g) | 0 | 0 | 0 | 0 | 0 | 0 | 0 | 0 | 0 | 0 | 0 |
| 11 | Poly un. fat (g) | 0.21 | 0.44 | 1.1926 | 1.069 | 73.12 | 0 | 0 | 0 | 0.128 | 0.98 | 46.6 |
| 12 | Mono un. fat (g) | 0.24 | 0.35 | 0.583 | 0.503 | 16.84 | 0 | 0 | 0 | 0.63 | 0.51 | 11.4 |
| 13 | Cholesterol (mg) | 0 | 0 | 0 | 0 | 0 | 0 | 0 | 0 | 0 | 0 | 0 |
| 14 | Sodium (mg) | 5 | 14 | 1187 | 120 | 0 | 4 | 38785 | 0 | 10 | 27 | 2300.0 |
| 15 | Non-fiber carbs | 78.65 | 6.10 | 3.48 | 0 | 0 | 81.66 | 0 | 98.1 | 27.49 | 57.52 | 275.0 |
| | (g) | | | | | | | | | | | |
| 16 | Dietary fiber (g) | 1.3 | 5.10 | 3.47 | 84.346 | 0 | 0.2 | 0 | 0 | 53.1 | 14.1 | 25.0 |
| 17 | Soluble fiber (g) | 0.32 | 0.259 | 0.33 | 50.799 | 0 | 0.2 | 0 | 0 | 27.48 | 7.71 | 13.056 |
| 18 | Insoluble fiber(g) | 0.98 | 4.841 | 3.14 | 33.547 | 0 | 0 | 0 | 0 | 25.62 | 6.39 | 11.944 |
| 19 | Sugars (g) | 0.12 | 4.01 | 0.25 | 0 | 0 | 82.1 | 0 | 0 | 2.17 | 3.4 | 88.5 |
| 20 | Proteins (g) | 7.13 | 81.95 | 86.76 | 2.576 | 0 | 0.3 | 0 | 0.56 | 3.99 | 8.98 | 50.0 |
| 21 | Sum of | 100.0 | 100.0 | 100.0 | 100.0 | 100.0 | 100.0 | 100.0 | 100.0 | 100.0 | 100.0 | |
| | proximates (g) | | | | | | | | | | | |

Compare with
Recommended
Daily Intake

| | | 100% | |
|---|---|---|---|
| | | DV | |
| Grand Total | | (ref.) - | % of DV - |
| 472.60 | Total Weight (g) | — | — |
| 49.9 | Moisture (g) | — | — |
| 7.7 | Ash (g) | — | — |
| 1935.0 | Calories | — | — |
| 65.0 | Total fat (g) | 65 | 100% |
| 7.0 | Sat. fat (g) | 20 | 35.0% |
| 0.0 | Trans fat (g) | — | — |
| 46.6 | Poly un. fat (g) | — | — |
| 11.4 | Mono un. fat (g) | — | — |
| 0.0 | Cholesterol (mg) | 300 | 0 |
| 2300.0 | Sodium (mg) | 2300 | 100% |
| 275.0 | Non-fiber carbs (g) | 275 | 100% |
| 25.0 | Dietary fiber (g) | 25.00 | 100% |
| 13.056 | Soluble fiber (g) | — | — |
| 11.944 | Insoluble fiber(g) | — | — |
| 88.5 | Sugars (g) | — | — |
| 50.0 | Proteins (g) | 50 | 100 |

In this table, numbers below the row entitled “Mass in recipe (g)” in the “Grand Total” column correspond to weighted sums of each contributing ingredient. Total Fat, for example, is found via the following calculation: (0.66 g per serving white rice flour×2.3206 servings of white rice flour)+(1.34 g per serving brown rice protein×0.099 servings of brown rice protein)+(2.2 g per serving pea protein×0.2771 servings of pea protein)+(1.571 g per serving psyllium husk powder×0.205 servings of psyllium husk powder)+(100 g per serving of grapeseed oil×0.622 servings of grapeseed oil)+(0.03 g per serving Reb M×0.01 servings of Reb M)+(1.24 g per serving cinnamon×0.05 servings of cinnamon)+(4.24 g per serving ginger×0.025 servings of ginger)=(1.5316 g)+(0.13266 g)+(0.61 g)+(0.322 g)+(62.2 g)+(0.0003 g)+(0.07688 g)+(0.106 g)=64.97944 g, 65 g total fat. The solid foodstuff described herein may be used as a meal replacement and can appeal to the “busy lifestyle” customers due to better flavor and dietary compatibility compared to meal replacements available on the market.

Exemplary Foodstuff: Crisps White rice flour (284 g), brown rice protein (9.229 g), yellow pea protein (27.708 g), salt (5.233 g), and stevia extract (1.75 g) are weighed and added to a mixing bowl. Grapeseed oil (62.235 g) is weighed and poured into a blending apparatus. Psyllium husk powder 20.504 g) is weighed and added to a blending apparatus. Honey (106.685 g) is weighed in the same weighing boat as the oil in order to prevent it from sticking to the surface of the boat and facilitate pouring into the blending apparatus. Approximately 250 g of water is also weighed and poured into the blending apparatus, then blended for ˜3 minutes or until ingredients have gelled together into one large mass using a Breville hand blender. The ingredients are then added to the mixing bowl with the dry ingredients and mixed until they create a homogeneous, singular lump of dough. A KitchenAide KSM150PSAC1 was used, on the lowest speed (2) to avoid attrition of powdered ingredients. If dough continues to crumble, water is added in approximately 15 g increments until crumbling ceases. 16.8 g of lemon extract may be added. Alternatively, 5 g of ground cinnamon and 4 g of ground ginger may be added to dough while it is still being mixed. If dough begins to exhibit signs of crumbling again, 10-15 g of water may be added to mitigate the effect. Then dough is rolled to a thickness of 1 mm (maximum), cut using a circular cookie cutter, and placed on a pizza sheet made of expanded aluminum. The crisps are then placed in a standard convection oven that has been pre-heated to 350° F., and let to cook for 3 minutes. After removing, they are allowed to cool for 5-10 minutes, then placed in a Nesco food dehydrator for 24 hours at a setting of 130° F. or 135° F.

Calculating Caloric and Macronutrient Content of the Foodstuff

The Food and Drug Administration (FDA) Daily issues guidelines as Daily Recommended Values (DRV) of food components for individual consumption.

However, Daily Reference Values differ in the 1990 and 2016 guidelines. The differences are summarized in Table 5 as follows.

TABLE 5
Comparison of the Daily Reference Values (DRV)
according to the 1990 and 2016 FDA guidelines

| Ingredient | DRV (1990)* | DRV (2016)** |
|---|---|---|
| Fat (g) | 65 | 78 |
| Saturated fatty acids (g) | 20 | 20 |
| Cholesterol (mg) | 300 | 300 |
| Fiber (g) | 25 | 28 |
| Carbohydrates (g) | 300 | 275 |
| Sodium (mg) | 2400 | 2300 |

*21 C.F.R. §101.9 (revised in 2015, includes guidelines adopted in 1990)
**21 C.F.R. §101.9 (revised in 2017, includes guidelines adopted in 2016)

As evident from Table 5, the FDA revised the recommended daily reference values for fat, fiber, carbohydrates and sodium.

According to the 1990 regulations, the daily reference values (DRV) for carbohydrates, fat, fiber, and protein were 300 g, 65 g, 25 g, and 50 g, respectfully. However, there are a number of aspects to food labeling that are not readily apparent to average consumers. For instance, the values for both soluble and insoluble fiber (found on a food label) are also included in the total carbohydrates value. For example, if a serving of a particular food has a Total Carbohydrates value of 50 g and a Total Dietary Fiber value of 5 g, then 10% of the Total Carbohydrates figure is composed of fiber. Because the values (DRV) for carbohydrates and fiber are 300 g and 25 g, respectively, 275 g of carbohydrates should be free of fiber under the 1990 regulations (300 g carbohydrates−25 g of fiber=275 g fiber-free carbohydrates).

According to the 1990 regulations, the general rule for determining the calorie content of foods is as follows:

9 calories per gram of fat

4 calories per gram of protein

4 calories per gram of carbohydrates

This rule applies to non-fiber carbohydrates, and soluble fiber

The caloric value from carbohydrates can be calculated using the following equation:

CaloriesCarbohydrates=4caloriesgram×(GramsTotal Carbohy [symbol] rates−GramsInsoluble Fiber)

A preferred intake ratio of soluble fiber to insoluble fiber is not known. However, empirical medical data indicates that soluble and insoluble types of fiber positively affect an individual's health. To design nutritionally-balanced foodstuff, the target for carbohydrates includes ½ soluble fiber and ½ insoluble fiber, or 12.5 g of each of soluble and insoluble fiber of 25 g total dietary fiber. Additionally, the inclusion of soluble fiber into the recipe changes caloric values of other components as shown in Table 6.

TABLE 6
Total caloric values* of a nutritionally-balanced solid foodstuff
including soluble fiber vs. no soluble fiber

| Foodstuff with No Soluble fiber | | | | | Foodstuff with Max Soluble fiber | | | |
|---|---|---|---|---|---|---|---|---|
| | | | | % of | | | | % of |
| | Weight | | | total | Weight | | | total |
| Component | (g) | Cals/g | Cals | cals | (g) | Cals/g | Cals | cals |
| Fat | 78 | 9 | 702 | 36.9 | 78 | 9 | 702 | 35.9 |
| Non-fiber | 250 | 4 | 1000 | 52.6 | 250 | 4 | 1000 | 51.1 |
| carbs | | | | | | | | |
| Total fiber | 28 | 0 | | 0.0 | 28 | 0 | | 0.0 |
| Soluble | 0 | 0 | 0 | 0.0 | 28 | 2 | 56 | 2.9% |
| fiber** | | | | | | | | |
| Protein | 50 | 4 | 200 | 10.5 | 50 | 4 | 200 | 10.2% |
| Total calories | | | 1902 | | | | 1958 | |

*Caloric values are calculated based on the 2016 FDA guidelines.
**Soluble fiber contributes 2 calories per gram of soluble fiber if included in the recipe.

The calorie count resulting from the sum of the macronutrients values may not be the exact match of the recommended caloric intake of 2,000 calories. For examples, 65 g of fat corresponds to 585 calories, 50 g of protein corresponds 200 calories, and 275 g of non-fiber carbohydrates corresponds to 1100 calories. If 100% of the DRV for total dietary fiber (25 g) is soluble fiber, then the total dietary fiber contributes 100 calories. However, if the target fiber in the foodstuff recipe is 12.5 g of soluble fiber and 12.5 g of insoluble fiber, then the fiber only contributes 50 calories toward the total calorie count, and the total caloric value of the designed foodstuff may result in 1935 calories (585 calories from fat+1100 calories from non-fiber carbohydrates+50 calories from fiber+200 calories from protein=1935 calories) or the 65 calories deviation from the recommended intake of 2000 calories.

The discrepancy between the total calories from macronutrients in the designed foodstuff and the reference value of 2,000 calories requires adjustment of the amount of food to be included in a serving or package to satisfy the FDA requirements. Although the relative nutritional value per unit weight is constant, the adjustment of the percent daily values on the nutrition label may vary based upon the serving size presented.

For example, for a serving size of ⅕ of the total daily macronutrient requirements corresponds to 20% DRV for all macronutrients, and the foodstuff designed to include 1935 calories of the target daily intake based upon the caloric contributions of all of the recommended macronutrients. Table 7 illustrates the food label for the foodstuff designed based on 1935 calorie intake.

TABLE 7
An exemplary Nutritional Label That Adheres to the
1990 FDA Guidelines (387 calories).
NUTRITION FACTS
Serving Size: 43 Crisps (approx. 94.5 grams)
No. of Servings per Package: 5
Amount Per Serving

| | |
|---|---|
| | Calories from Fat 117 |
| Calories 387 | % Daily Value |

| Total Fat 13 g | | | 20% |
|---|---|---|---|
| Saturated Fat 1.40 g | | | 7.0% |
| Polyunsaturated Fat 9.3 g | | | |
| Monounsaturated Fat 2.3 g | | | |
| Trans Fat 0 g | | | |
| Cholesterol 0 mg | | | 0% |
| Sodium 460 mg | | | 20% |
| Total Carbohydrates 60 g | | | 20% |
| Total Dietary Fiber 5.0 g | | | 20% |
| Soluble Fiber 2.6 g | | | |
| Insoluble Fiber 2.4 g | | | |
| Sugars 17.7 g | | | |
| Protein 10 g | | | 20% |
| Vitamin A | 20% | Vitamin C | 20% |
| Calcium | 20% | Iron | 20% |
| Vitamin D | 20% | Vitamin E | 20% |
| Vitamin K | 20% | Thiamin | 20% |
| Riboflavin | 20% | Niacin | 20% |
| Vitamin B-6 | 20% | Folate | 20% |
| Biotin | 20% | Vitamin B-5 | 20% |
| Vitamin B-12 | 20% | Phosphorus | 20% |
| Iodine | 20% | Magnesium | 20% |
| Zinc | 20% | Selenium | 20% |
| Copper | 20% | Manganese | 20% |
| Chromium | 20% | Molybdenum | 20% |
| Chloride | 20% | Potassium | 20% |

To adjust a serving size based upon a target daily calorie consumption of 2000 calories, all of the macronutrients have to be proportionally scaled up in order to make their caloric contributions sum to 2000 calories. The resultant macronutrient contributions are 20.67% (˜21%) per a 400 calorie serving size as illustrated in Table 8.

TABLE 8
An exemplary Nutritional Label That Adheres to the
1990 FDA Guidelines (400 calories)
NUTRITION FACTS
Serving Size: 44.5 Crisps (approx. 97.7 grams)
No. of Servings per Package: 5
Amount Per Serving

| | |
|---|---|
| | Calories from Fat 121 |
| Calories 400 | % Daily Value |

| Total Fat 13.4 g | | | 21% |
|---|---|---|---|
| Saturated Fat 1.44 g | | | 7.2% |
| Polyunsaturated Fat 9.6 g | | | |
| Monounsaturated Fat 2.4 g | | | |
| Trans Fat 0 g | | | |
| Cholesterol 0 mg | | | 0% |
| Sodium 475 mg | | | 21% |
| Total Carbohydrates 62 g | | | 21% |
| Total Dietary Fiber 5.2 g | | | 21% |
| Soluble Fiber 2.7 g | | | |
| Insoluble Fiber 2.5 g | | | |
| Sugars 18.3 g | | | |
| Protein 10.3 g | | | 21% |
| Vitamin A | 21% | Vitamin C | 21% |
| Calcium | 21% | Iron | 21% |
| Vitamin D | 21% | Vitamin E | 21% |
| Vitamin K | 21% | Thiamin | 21% |
| Riboflavin | 21% | Niacin | 21% |
| Vitamin B-6 | 21% | Folate | 21% |
| Biotin | 21% | Vitamin B-5 | 21% |
| Vitamin B-12 | 21% | Phosphorus | 21% |
| Iodine | 21% | Magnesium | 21% |
| Zinc | 21% | Selenium | 21% |
| Copper | 21% | Manganese | 21% |
| Chromium | 21% | Molybdenum | 21% |
| Chloride | 21% | Potassium | 21% |

The discrepancy between the recommended caloric intake and the recommended micro—and macronutrients intake applies to both the 1990 and the 2016 FDA guidelines.

The calorie values presented for a given serving size of this foodstuff depend upon the specific micro- and macronutrient guidelines. Furthermore, the FDA does not provide a recommendation for soluble fiber intake in either the 1990 or the 2016 guidelines. In 1990, the FDA required foodstuff calorie calculations to utilize 4 calories per gram of soluble fiber. In contrast, the 2016 guidelines changed this requirement to 2 calories per gram. The 2016 guidelines also stipulate that the only fiber that is to be counted on a nutrition label must be derived from a limited set of approved sources. Therefore, the calories drawn from a selected micro- and macronutrient profile may vary depending on the FDA requirements being followed. A food recipe that is balanced under the 1990 guidelines has to be adjusted the micro- and macronutrient requirements under the 2016 guidelines. The recipe disclosed in Table 4, which was adjusted according to the 2016 guidelines is shown in Table 9. Table 9 includes calculation of Grand Total values similar to those described for Table 4.

TABLE 9
Ingredients and Nutritive Content Breakdown of Solid Foodstuff (2016 FDA Guidelines)

| | | B | C | D | E | F | | | | | | |
|---|---|---|---|---|---|---|---|---|---|---|---|---|
| | A | White | Brown | Yellow | Psyllum | Grape | | H | | | | L |
| | In- | Rice | Rice | Pea | Husk | Seed | G | Table | I | J | K | Grand |
| 1 | gredient | Flour | Protein | Protein | Powder | Oil | Honey | Salt | Reb M | Cinnamon | Ginger | Total |
| 2 | Refer- | 100 g | 100 g | 100 g | 100 g | 100 g | 100 g | 100 g | 100 g | 100 g | 100 g | |
| | ence | | | | | | | | | | | |
| | amount | | | | | | | | | | | |
| 3 | Refer- | 2.16619 | 0.1125 | 0.276864 | 0.242663 | 0.7526 | 0.8717 | 0.0497 | 0.01 | 0.05 | 0.025 | |
| | ence | | | | | | | | | | | |
| | multi- | | | | | | | | | | | |
| | plier | | | | | | | | | | | |
| 4 | Mass in | 216.619 | 11.248 | 27.686 | 24.266 | 75.261 | 87.17 | 4.967 | 1.000 | 5.000 | 2.500 | 455.72 |
| | recipe | | | | | | | | | | | |
| | (g) | | | | | | | | | | | |
| 5 | Mois- | 12.16 | 3.88 | 0 | 8.612631 | 0 | 17.6 | 0.2 | 1.31 | 10.58 | 9.94 | 45.0 |
| | ture | | | | | | | | | | | |
| | (g) | | | | | | | | | | | |
| 6 | Ash (g) | 0.1 | 1.63 | 4.09 | 2.894083 | 0 | 0.24 | 99.8 | 0 | 3.6 | 5.22 | 7.7 |
| 7 | Calories | 364.36 | 364.78 | 381.42 | 126.0443 | 884 | 303.6 | 0 | 395 | 192.04 | 319.58 | 1918.0 |
| 8 | Total | 0.66 | 1.34 | 2.2 | 1.571358 | 100 | 0 | 0 | 0.03 | 1.24 | 4.24 | 78.0 |
| | fat | | | | | | | | | | | |
| | (g) | | | | | | | | | | | |
| 9 | Sat. fat | 0.20842 | 0.5548 | 0.42438 | 0 | 10.042 | 0 | 0 | 0 | 0.6432 | 2.7501 | 8.3 |
| | (g) | | | | | | | | | | | |
| 10 | Trans | 0 | 0 | 0 | 0 | 0 | 0 | 0 | 0 | 0 | 0 | 0 |
| | fat | | | | | | | | | | | |
| | (g) | | | | | | | | | | | |
| 11 | Poly | 0.20842 | 0.4397 | 1.19262 | 1.068523 | 73.117 | 0 | 0 | 0 | 0.128 | 0.983 | 56.2 |
| | un. fat | | | | | | | | | | | |
| | (g) | | | | | | | | | | | |
| 12 | Mono | 0.24315 | 0.3455 | 0.583 | 0.502834 | 15.841 | 0 | 0 | 0 | 0.4629 | 0.5069 | 13.6 |
| | un. fat | | | | | | | | | | | |
| | (g) | | | | | | | | | | | |
| 13 | Choles- | 0 | 0 | 0 | 0 | 0 | 0 | 0 | 0 | 0 | 0 | 0 |
| | terol | | | | | | | | | | | |
| | (mg) | | | | | | | | | | | |
| 14 | Sodium | 5 | 14 | 1187 | 120 | 0 | 4 | 38785 | 0 | 10 | 27 | 2300.0 |
| | (mg) | | | | | | | | | | | |
| 15 | Non- | 78.65 | 6.10 | 3.48 | 0 | 0 | 81.66 | 0 | 98.1 | 27.49 | 57.52 | 247.0 |
| | fiber | | | | | | | | | | | |
| | carbs | | | | | | | | | | | |
| | (g) | | | | | | | | | | | |
| 16 | Dietary | 1.3 | 5.1 | 3.47 | 84.3461 | 0 | 0.2 | 0 | 0 | 53.1 | 14.1 | 28.0 |
| | fiber (g) | | | | | | | | | | | |
| 17 | Soluble | 0.32 | 0.2593 | 0.33 | 50.79935 | 0 | 0.2 | 0 | 0 | 27.48 | 7.71 | 14.882 |
| | fiber (g) | | | | | | | | | | | |
| 18 | In- | 0.98 | 4.8407 | 3.14 | 33.54674 | 0 | 0 | 0 | 0 | 27.48 | 7.71 | 14.882 |
| | soluble | | | | | | | | | | | |
| | fiber (g) | | | | | | | | | | | |
| 19 | Sugars | 0.12 | 4.01 | 0.25 | 0 | 0 | 82.1 | 0 | 0 | 2.17 | 3.4 | 72.5 |
| | (g) | | | | | | | | | | | |
| 20 | Proteins | 7.13 | 81.95 | 86.76 | 2.576 | 0 | 0.3 | 0 | 0.56 | 3.99 | 8.98 | 50.0 |
| | (g) | | | | | | | | | | | |
| 21 | Sum of | 100.0 | 100.0 | 100.0 | 100.0 | 100.0 | 100.0 | 100.0 | 100.0 | 100.0 | 100.0 | |
| | proxi- | | | | | | | | | | | |
| | mates | | | | | | | | | | | |
| | (g) | | | | | | | | | | | |

Compare with
Recommended
Daily Intake

| | | 100% | |
|---|---|---|---|
| | | DV | |
| Grand Total | | (ref.) - | % of DV - |
| 455.72 | Total Weight (g) | — | — |
| 45.0 | Moisture (g) | — | — |
| 7.7 | Ash (g) | — | — |
| 1918.0 | Calories | — | — |
| 78.0 | Total fat (g) | 78 | 100% |
| 8.3 | Sat. fat (g) | 20 | 35.0% |
| 0.0 | Trans fat (g) | — | — |
| 56.2 | Poly un. fat (g) | — | — |
| 13.6 | Mono un. fat (g) | — | — |
| 0.0 | Cholesterol (mg) | 300 | 0 |
| 2300.0 | Sodium (mg) | 2300 | 100% |
| 247.8 | Non-fiber carbs (g) | 247 | 100% |
| 28.0 | Dietary fiber (g) | 28.00 | 100% |
| 14.882 | Soluble fiber (g) | — | — |
| 13.118 | Insoluble fiber(g) | — | — |
| 72.5 | Sugars (g) | — | — |
| 50.0 | Proteins (g) | 50 | 100 |

Nutritional labels were also modified. An exemplary nutritional label for 383.6 calories of the foodstuff that adheres to the 2016 guidelines is shown in Table 10.

TABLE 10
An exemplary Nutritional Label That Adheres to the
2016 FDA Guidelines (383.6 calories)
NUTRITION FACTS
Serving Size: 76.8 Crisps (approx. 91.14 grams)
No. of Servings per Package: 5
Amount Per Serving

| | |
|---|---|
| | Calories from Fat 133.1 |
| Calories 383.6 | % Daily Value |

| Total Fat 15.6 g | | | 20% |
|---|---|---|---|
| Saturated Fat 1.66 g | | | 8.3% |
| Polyunsaturated Fat 11.23 g | | | |
| Monounsaturated Fat 2.71 g | | | |
| Trans Fat 0 g | | | |
| Cholesterol 0 mg | | | 0% |
| Sodium 460 mg | | | 20% |
| Total Carbohydrates 55 g | | | 20% |
| Total Dietary Fiber 5.6 g | | | 20% |
| Soluble Fiber 2.98 g | | | |
| Insoluble Fiber 2.62 g | | | |
| Sugars 14.51 g | | | |
| Protein 10 g | | | 20% |
| Vitamin A | 20% | Vitamin C | 20% |
| Calcium | 20% | Iron | 20% |
| Vitamin D | 20% | Vitamin E | 20% |
| Vitamin K | 20% | Thiamin | 20% |
| Riboflavin | 20% | Niacin | 20% |
| Vitamin B-6 | 20% | Folate | 20% |
| Biotin | 20% | Vitamin B-5 | 20% |
| Vitamin B-12 | 20% | Phosphorus | 20% |
| Iodine | 20% | Magnesium | 20% |
| Zinc | 20% | Selenium | 20% |
| Copper | 20% | Manganese | 20% |
| Chromium | 20% | Molybdenum | 20% |
| Chloride | 20% | Potassium | 20% |

To adjust a serving size based upon a target daily calorie consumption of 2000 calories, all of the macronutrients have to be proportionally scaled up in order to make their caloric contributions sum to 2000 calories. The resultant macronutrient contributions are 20.67% (˜21%) per a 400 calorie serving size as illustrated in Table 11.

TABLE 11
An exemplary Nutritional Label That Adheres to the
2016 FDA Guidelines (400 calories)
NUTRITION FACTS
Serving Size: 80.1 Crisps (approx. 95.0 grams)
No. of Servings per Package: 5
Amount Per Serving

| | |
|---|---|
| | Calories from Fat 138.8 |
| Calories 400 | % Daily Value |

| Total Fat 16.3 g | | | 21% |
|---|---|---|---|
| Saturated Fat 1.73 g | | | 8.65% |
| Polyunsaturated Fat 11.71 g | | | |
| Monounsaturated Fat 2.82 g | | | |
| Trans Fat 0 g | | | |
| Cholesterol 0 mg | | | 0% |
| Sodium 480 mg | | | 21% |
| Total Carbohydrates 57.4 g | | | 21% |
| Total Dietary Fiber 5.9 g | | | 21% |
| Soluble Fiber 2.1 g | | | |
| Insoluble Fiber 2.7 g | | | |
| Sugars 15.1 g | | | |
| Protein 10.4 g | | | 21% |
| Vitamin A | 21% | Vitamin C | 21% |
| Calcium | 21% | Iron | 21% |
| Vitamin D | 21% | Vitamin E | 21% |
| Vitamin K | 21% | Thiamin | 21% |
| Riboflavin | 21% | Niacin | 21% |
| Vitamin B-6 | 21% | Folate | 21% |
| Biotin | 21% | Vitamin B-5 | 21% |
| Vitamin B-12 | 21% | Phosphorus | 21% |
| Iodine | 21% | Magnesium | 21% |
| Zinc | 21% | Selenium | 21% |
| Copper | 21% | Manganese | 21% |
| Chromium | 21% | Molybdenum | 21% |
| Chloride | 21% | Potassium | 21% |

The target amount of each food component in the recipes may be calculated using matrices, i.e., systems of linear equations. For example, if A is an m-by-n matrix, x designates a column vector (that is, n×1-matrix) of n variables x1, x2, . . . , xn, and b is an m×1-column vector), then the matrix equation is as follows:

Ax=b

The matrix equation is equivalent to the system of the following linear equations:

$$\begin{matrix}{A}_{1 , 1} {x}_{1} + {A}_{1 , 2} {x}_{2} + … + {A}_{1 , n} {x}_{n} = {b}_{1} \\ ⋮ \\ {A}_{m , 1} {x}_{1} + {A}_{m , 2} {x}_{2} + … + {A}_{m , n} {x}_{n} = {b}_{m}\end{matrix}$$

If n=m and the equations are independent, the following equation (1) can be used:

x=A⁻¹b,

where A⁻¹ is the inverse matrix of A.

For example, data in Tables 4 and 9 can be converted in matrices. Using the equation, where matrix ‘b’ is a 5×1 matrix representing the target values for calories, fat, carbohydrates, fiber, and protein on a daily basis and matrix ‘x’ is a 5×1 matrix represents the mass of each ingredient used in the recipe, the foodstuff recipe may be updated if new nutrition data for a particular ingredient is entered.

Nutrition data requires updates for a number of reasons, including a change in nutrition data due to a manufacturer using a new process, or switching ingredient suppliers altogether, for example.

For example, matrix A is a 6×6 matrix, but the nutrition content for each of the ingredients is found in rows 1-5. The sixth row may be present in order to balance the protein contribution between pea and rice proteins, where rice protein is the sum of the protein contributed from the brown rice protein isolate and white rice flour.

$$A = [ \begin{matrix}{A}_{1 , 1} & {A}_{1 , 2} & {A}_{1 , 3} & {A}_{1 , 4} & {A}_{1 , 5} & {A}_{1 , 6} \\ {A}_{2 , 1} & {A}_{2 , 2} & {A}_{2 , 3} & {A}_{2 , 4} & {A}_{2 , 5} & {A}_{2 , 6} \\ {A}_{3 , 1} & {A}_{3 , 2} & {A}_{3 , 3} & {A}_{3 , 4} & {A}_{3 , 5} & {A}_{3 , 6} \\ {A}_{4 , 1} & {A}_{4 , 2} & {A}_{4 , 3} & {A}_{4 , 4} & {A}_{4 , 5} & {A}_{4 , 6} \\ {A}_{5 , 1} & {A}_{5 , 2} & {A}_{5 , 3} & {A}_{5 , 4} & {A}_{5 , 5} & {A}_{5 , 6} \\ {A}_{6 , 1} & {A}_{6 , 2} & {A}_{6 , 3} & {A}_{6 , 4} & {A}_{6 , 5} & {A}_{6 , 6}\end{matrix} ]$$

$$b = [ \begin{matrix}{b}_{1} \\ {b}_{2} \\ {b}_{3} \\ {b}_{4} \\ {b}_{5} \\ {b}_{6}\end{matrix} ]$$

For the purposes of the recipe matrix math, the recipe is essentially a 5×5 matrix with each column containing the nutrition data in 100 g of a particular ingredient, and each row representing the nutrition components. Since the cinnamon, ginger, and very low-calorie sweetener (Reb M) are added to the recipe in predetermined amounts, their nutritional contribution to the overall recipe is subtracted from the daily nutritional target figures. This eliminates the potential for these ingredient quantities to change, which prevents the matrix math from becoming over-constrained.

The rest of the recipe is comprised of 6 ingredients: white rice flour, brown rice protein isolate, pea protein isolate, psyllium husk powder, honey, and grape seed oil, which results in a 5×6 matrix. A 5×6 matrix would be over-constrained, so one of the columns needed to be eliminated. This was done by combining the two protein isolates at a particular ratio, and substituting those two columns with an ingredient titled “protein blend” and updating the nutrition cells in that column according to the proportions of each ingredient. The protein ratio should be optimized in order to maximize the PDCAAS value: the optimization process requires an analysis of the amino acid profile of each and performing further calculations and comparison with the WHO recommendations [for amino acid intake] in order to then determine the best ratio of the two protein sources.

Calculating Nutritional Values of the Recipe with Sorghum Flour

TABLE 12
Nutritive Content Breakdown of Ingredients of Solid Foodstuff in Recipe with Sorghum Flour per 100 g reference

| | | | C | D | E | F | | | | | |
|---|---|---|---|---|---|---|---|---|---|---|---|
| | | B | Brown | Yellow | Psyllium | Grape | | H | | | |
| | A | Sorghum | Rice | Pea | Husk | seed | G | Table | I | J | K |
| 1 | Ingredient | Flour | Protein | Protein | Powder | oil | Honey | Salt | Reb. M | Cinnamon | Ginger |
| 2 | Reference amount | 100 | 100 | 100 | 100 | 100 | 100 | 100 | 100 | 100 | 100 |
| | (g) | | | | | | | | | | |
| 3 | Moisture (g) | 11.62 | 3.88 | 0 | 8.6 | 0 | 17.6 | 0.2 | 1.31 | 10.58 | 9.94 |
| 4 | Ash (g) | 0.64 | 1.63 | 4.09 | 2.9 | 0 | 0.24 | 99.8 | 0 | 3.6 | 5.22 |
| 5 | Calories | 365.0 | 365.3 | 382.1 | 227.6 | 884 | 304 | 0 | 395 | 247 | 335 |
| 6 | Total Fat (g) | 0.66 | 1.34 | 2.2 | 1.571 | 100 | 0 | 0 | 0.03 | 1.24 | 4.24 |
| 7 | Sat. Fat (g) | 0.18 | 0.55 | 0.4 | 0 | 10.04 | 0 | 0 | 0 | 0.649 | 2.75 |
| 8 | Trans Fat (g) | 0 | 0 | 0 | 0 | 0 | 0 | 0 | 0 | 0 | 0 |
| 9 | Poly Un. Fat (g) | 0.18 | 0.44 | 1.2 | 1.069 | 73.12 | 0 | 0 | 0 | 0.128 | 0.98 |
| 10 | Mono Un. Fat (g) | 0.21 | 0.35 | 0.583 | 0.503 | 16.84 | 0 | 0 | 0 | 0.463 | 0.51 |
| 11 | Cholesterol (mg) | 0 | 0 | 0 | 0 | 0 | 0 | 0 | 0 | 0 | 0 |
| 12 | Sodium (mg) | 5 | 14 | 1187 | 120 | 0 | 4 | 38758 | 0 | 10 | 27 |
| 13 | Total | 79.95 | 11.2 | 6.95 | 84.35 | 0 | 81.86 | 0 | 98.1 | 80.59 | 71.62 |
| | Carbohydrates (g) | | | | | | | | | | |
| 14 | Non-Fiber Carbs | 78.65 | 6.10 | 3.48 | 0 | 0 | 81.66 | 0 | 98.1 | 27.49 | 57.52 |
| | (g) | | | | | | | | | | |
| 15 | Dietary Fiber (g) | 1.3 | 5.10 | 3.47 | 84.35 | 0 | 0.2 | 0 | 0 | 53.1 | 14.1 |
| 16 | Soluble Fiber (g) | 0.32 | 0.3 | 0.33 | 50.80 | 0 | 0.2 | 0 | 0 | 27.48 | 7.71 |
| 17 | Insoluble Fiber (g) | 0.98 | 4.8 | 3.14 | 33.55 | 0 | 0 | 0 | 0 | 25.62 | 6.39 |
| 18 | Sugars (g) | 0.12 | 4.01 | 0.25 | 0 | 0 | 82.1 | 0 | 0 | 2.17 | 3.4 |
| 19 | Protein (g) | 7.13 | 81.95 | 86.76 | 2.576 | 0 | 0.3 | 0 | 0.56 | 3.99 | 8.98 |
| 20 | Sum of | 100.0 | 100.0 | 100.0 | 100.0 | 100.0 | 100.0 | 100.0 | 100.0 | 100.0 | 100.0 |
| | Proximates (g) | | | | | | | | | | |

The updated recipe that lists sorghum flour is shown in Table 12. The data in this table was obtained empirically or from publicly available sources. An example of the calculation of the nutritional values of the Recipe, in which white rice flour was substituted with sorghum flour is described herein.

Step 1: Make a decision regarding the nutritive content of the final recipe.

In this example, the following nutritive content was selected:

Calories: 1935

Total Fat (g): 65

Non-Fiber Carbohydrates (g): 275

Total Dietary Fiber (g): 25

Protein (g): 50

Step 2: Adjust the values in Step 1 to compensate for nutritive contribution of all flavoring agents (except table salt).

The quantities of the following ingredients have been experimentally determined based on informal taste-testing trials of samples that incorporated varying levels of each ingredient:

| | Reb M* | Cinnamon* | Ginger* |
|---|---|---|---|
| | (100 g) | (100 g) | (100 g) |
| Calories | 395 | 247 | 335 |
| Total Fat (g) | 0.03 | 1.24 | 4.24 |
| Non-Fiber Carbohydrates (g) | 98.1 | 27.49 | 57.52 |
| Total Dietary Fiber (g) | 0 | 53.1 | 14.1 |
| Protein (g) | 0.56 | 3.99 | 8.98 |

*Reference Nutrition Data (available from the manufacturer or USDA National Nutrient Database)

| | Reb M | Cinnamon | Ginger | |
|---|---|---|---|---|
| | 1 gram | 5 grams | 2.5 grams | Total |
| Calories | 3.95 | 12.35 | 8.375 | 24.675 |
| Total Fat (g) | 0.0003 | 0.062 | 0.106 | 0.1683 |
| Non-Fiber | 0.981 | 1.3745 | 1.438 | 3.7935 |
| Carbohydrates (g) | | | | |
| Total Dietary Fiber (g) | 0 | 2.655 | 0.3525 | 3.0075 |

The following values were used for the solution matrix (matrix b):

Calories: 1935−24.675=1910 (b1)

Total Fat (g): 65−0.1683=64.8 (2)

Non-Fiber Carbohydrates (g): 275−3.7935=271 (b3)

Total Dietary Fiber (g): 25−3.0075=22 (b4)

Protein (g): 50−0.4296=49.6 (b5)

Step 3: Substitute values A_{1,1} through A_{5,6} with the reference values for each ingredient, i.e., calories in row B5 to H5, fat in row B6 to H6, non-fiber carbohydrates in row B14 to H14, dietary fiber in row B15 to H15, and protein in row B19 to H19, on a 100 g basis, from Table 12, in which each column represents a different ingredient.

$$A = [ \begin{matrix}{A}_{1 , 1} & {A}_{1 , 2} & {A}_{1 , 3} & {A}_{1 , 4} & {A}_{1 , 5} & {A}_{1 , 6} \\ {A}_{2 , 1} & {A}_{2 , 2} & {A}_{2 , 3} & {A}_{2 , 4} & {A}_{2 , 5} & {A}_{2 , 6} \\ {A}_{3 , 1} & {A}_{3 , 2} & {A}_{3 , 3} & {A}_{3 , 4} & {A}_{3 , 5} & {A}_{3 , 6} \\ {A}_{4 , 1} & {A}_{4 , 2} & {A}_{4 , 3} & {A}_{4 , 4} & {A}_{4 , 5} & {A}_{4 , 6} \\ {A}_{5 , 1} & {A}_{5 , 2} & {A}_{5 , 3} & {A}_{5 , 4} & {A}_{5 , 5} & {A}_{5 , 6} \\ {A}_{6 , 1} & {A}_{6 , 2} & {A}_{6 , 3} & {A}_{6 , 4} & {A}_{6 , 5} & {A}_{6 , 6}\end{matrix} ]$$

$$b = [ \begin{matrix}{b}_{1} \\ {b}_{2} \\ {b}_{3} \\ {b}_{4} \\ {b}_{5} \\ {b}_{6}\end{matrix} ] x = [ \begin{matrix}{x}_{1 , 1} \\ {x}_{2 , 1} \\ {x}_{3 , 1} \\ {x}_{4 , 1} \\ {x}_{5 , 1} \\ {x}_{6 , 1}\end{matrix} ]$$

However, in order to balance the quantities of rice protein and pea protein, the data in row A_{6,1}-A_{6,5} is calculated as follows:
A_{6,1}=A_{5,1}
A_{6,2}=A_{5,2}
A_{6,3}=−A_{5,3}
A_{6,4}=0
A_{6,5}=0
A_{6,6}=0
b₆=0

Additionally, variables b1-b5 are replaced with the adjusted target values (determined in Step 2).

Step 3a: Given the values in the “Ingredient Nutrition (on a 100 g basis)” table, matrix ‘A’ above that includes values for calories, total fat, non-fiber carbohydrates, dietary fiber, and protein from Table 12 are shown below (left). Additionally, the data from Step 2 appears as is illustrated in matrix ‘b’ below (right):

$$A = [ \begin{matrix}365 & 365.297 & 382.08 & 227.643 & 884 & 304 \\ 0.66 & 1.34 & 2.2 & 1.57136 & 100 & 0 \\ 78.65 & 6.1 & 3.48 & 0 & 0 & 81.66 \\ 1.3 & 5.1 & 3.47 & 84.3461 & 0 & 0.2 \\ 7.13 & 81.95 & 86.76 & 2.57583 & 0 & 0.3 \\ 7.13 & 81.95 & - 86.76 & 0 & 0 & 0\end{matrix} ]$$

$$b = [ \begin{matrix}1910.325 \\ 64.8317 \\ 271.2065 \\ 21.9925 \\ 49.5704 \\ 0\end{matrix} ]$$

Step 4: Determine the inverse of Matrix ‘A’ (Step 3a).

$${A}^{- 1} = [ \begin{matrix}0.02695 & - 0.23820 & - 0.09977 & - 0.06507 & - 0.10538 & 0.00064 \\ - 0.00229 & 0.02028 & 0.00847 & 0.00535 & 0.01508 & 0.00605 \\ 0.00005 & - 0.00042 & - 0.00020 & - 0.00029 & 0.00559 & - 0.00576 \\ - 0.00022 & 0.00192 & 0.00078 & 0.01240 & 0.00024 & - 0.00014 \\ - 0.00014 & 0.01128 & 0.00054 & 0.00017 & 0.00037 & 4.46 - 05 \\ - 0.02578 & 0.22792 & 0.10771 & 0.06228 & 0.10013 & - 0.00082\end{matrix} ]$$

Step 5: Determine matrix ‘x’ by multiplying matrix A⁻¹ by matrix ‘b.’ The resultant values x₁, x₂, x₃, x₄, x₅, and x₆ are the reference multipliers for each ingredient, i.e., sorghum flour, brown rice protein, yellow pea protein, psyllium husk grapeseed oil, and honey from Table 12, and entered as row 2 in Table 13. The total mass for each ingredient from is determined by multiplying the ‘reference multiplier’ with 100, that is, the reference weight of 100 g of sorghum flour, brown rice protein, yellow pea protein, psyllium husk grapeseed oil, and honey and entered as row 3 in Table 13.

$$X = [ \begin{matrix}2.32022 \\ 0.0954 \\ 0.28078 \\ 0.20513 \\ 0.62232 \\ 1.06738\end{matrix} ]$$

Step 6 (final step): Determine the quantity of the sodium via the following steps:

6a: Subtract {the total quantity of sodium contributed by all other ingredients} from 2400

6b: Divide the number (from step 6a) by the reference sodium value (based on 100 g); this value is found in cell H12 of the “Ingredient Nutrition (on a 100 g basis)” Table 12

6c: The value determined in steps 6a and 6b is the ‘reference multiplier’; the total mass of the sodium contributed by table salt is determined by multiplying the ‘reference multiplier’ with the amount of sodium in 100 g of table salt (38758; found in cell H12 of the “Ingredient Nutrition (on a 100 g basis)” Table 12).

The nutritional values of the ingredients as determined in steps 1-6 are presented in Table 13.

TABLE 13
Ingredients and Nutritive Content Breakdown of Solid Foodstuff Calculated for Recipe with Sorghum Flour

| | | | C | | E | | | | | | | |
|---|---|---|---|---|---|---|---|---|---|---|---|---|
| | | B | Brown | D | Psyllium | F | | H | | | | Sum of |
| | A | Sorghum | Rice | Yellow Pea | Husk | Grape | G | Table | I | K | L | each |
| 1 | Ingredient | Flour | Protein | Protein | Powder | seed oil | Honey | Salt | Reb M | Cinnamon | Ginger | row |
| 2 | Reference | 2.320 | 0.095 | 0.281 | 0.205 | 0.622 | 1.067 | 0.052 | 0.01 | 0.05 | 0.025 | |
| | Multiplier* | | | | | | | | | | | |
| 3 | Mass in | 232.022 | 9.540 | 28.078 | 20.513 | 62.232 | 106.738 | 5.221 | 1.000 | 5.000 | 2.500 | 472.845 |
| | recipe (g) | | | | | | | | | | | |
| 4 | Moisture (g) | 26.961 | 0.370 | 0.000 | 1.767 | 0.000 | 18.786 | 0.010 | 0.013 | 0.529 | 0.249 | 48.685 |
| 5 | Ash (g) | 1.485 | 0.155 | 1.148 | 0.594 | 0.000 | 0.256 | 5.211 | 0.000 | 0.180 | 0.131 | 9.160 |
| 6 | Calories | 846.879 | 34.848 | 107.282 | 46.696 | 550.135 | 324.484 | 0.000 | 3.950 | 12.350 | 8.375 | 1935.0 |
| 7 | Total Fat (g) | 1.531 | 0.128 | 0.618 | 0.322 | 62.232 | 0.000 | 0.000 | 0.000 | 0.062 | 0.106 | 65.000 |
| 8 | Sat. Fat (g) | 0.418 | 0.053 | 0.119 | 0.000 | 6.249 | 0.000 | 0.000 | 0.000 | 0.032 | 0.069 | 6.940 |
| 9 | Trans Fat (g) | 0.000 | 0.000 | 0.000 | 0.000 | 0.000 | 0.000 | 0.000 | 0.000 | 0.000 | 0.000 | 0.000 |
| 10 | Poly Un. Fat | 0.418 | 0.042 | 0.335 | 0.219 | 45.503 | 0.000 | 0.000 | 0.000 | 0.006 | 0.025 | 46.547 |
| | (g) | | | | | | | | | | | |
| 11 | Mono Un. | 0.487 | 0.033 | 0.164 | 0.103 | 10.481 | 0.000 | 0.000 | 0.000 | 0.023 | 0.013 | 11.303 |
| | Fat (g) | | | | | | | | | | | |
| 12 | Cholesterol | 0.000 | 0.000 | 0.000 | 0.000 | 0.000 | 0.000 | 0.000 | 0.000 | 0.000 | 0.000 | 0.000 |
| | (mg) | | | | | | | | | | | |
| 13 | Sodium (mg) | 11.601 | 1.336 | 333.292 | 24.616 | 0.000 | 4.270 | 2023.712 | 0.000 | 0.500 | 0.675 | 2400.0 |
| 14 | Total | 185.501 | 1.068 | 1.951 | 17.302 | 0.000 | 87.376 | 0.000 | 0.981 | 4.030 | 1.791 | 300.00 |
| | Carbohydrates | | | | | | | | | | | |
| | (g) | | | | | | | | | | | |
| 15 | Non-Fiber | 182.485 | 0.582 | 0.977 | 0.000 | 0.000 | 87.162 | 0.000 | 0.981 | 1.375 | 1.438 | 275.00 |
| | Carbs (g) | | | | | | | | | | | |
| 16 | Dietary Fiber | 3.016 | 0.487 | 0.974 | 17.302 | 0.000 | 0.213 | 0.000 | 0.000 | 2.655 | 0.353 | 25.000 |
| | (g) | | | | | | | | | | | |
| 17 | Soluble | 0.742 | 0.025 | 0.093 | 10.420 | 0.000 | 0.213 | 0.000 | 0.000 | 1.374 | 0.193 | 13.06 |
| | Fiber (g) | | | | | | | | | | | |
| 18 | Insoluble | 2.274 | 0.462 | 0.882 | 6.881 | 0.000 | 0.000 | 0.000 | 0.000 | 1.281 | 0.160 | 11.939 |
| | Fiber (g) | | | | | | | | | | | |
| 19 | Sugars (g) | 0.278 | 0.383 | 0.070 | 0.000 | 0.000 | 87.632 | 0.000 | 0.000 | 0.109 | 0.085 | 88.557 |
| 20 | Protein (g) | 16.543 | 7.818 | 24.361 | 0.528 | 0.000 | 0.320 | 0.000 | 0.006 | 0.200 | 0.225 | 50.000 |
| 21 | Sum of | 232.022 | 9.540 | 28.078 | 20.513 | 62.232 | 106.738 | 5.221 | 1 | 5 | 2.5 | |
| | Proximates | | | | | | | | | | | |
| | (g) | | | | | | | | | | | |

Foodstuff Uses

Sourcing and preparing nutritious and well-balanced meals requires considerable effort by the consumer. Busy lifestyle causes consumers to look for well-balanced (nutritionally), and portable meals-to-go.

The foodstuff described herein provides consumers with a prepackaged food product that can provide 100% of the FDA-recommended daily value of all macro- and micro-nutrients, and provides a solution to the nutritious and well-balanced meal preparation aspect to the problem. The foodstuff described herein may be packed as a 1 bag, or 4-5 bags, that can provide nutritious meal for entire day.

The foodstuff in the format of snack bars may be appealing to college students who often skip meals and eat snack bars as meal replacement or to provide energy until their next meal. The foodstuff in the form of a biscuit would also offer an inexpensive meal option both nutritious and convenient. The foodstuff described herein may be also appealing to hikers, backpackers, single parents and army personnel to sustain their active lifestyles and workout routines.

The foodstuff may be appealing to campers, consumers on restricted or low-calorie diets, celiac patients, lactose intolerant consumers, consumers suffering from nut allergies, vegetarians, and consumers on restricted diets due to their persuasions and/or religious beliefs.

The foodstuff may be used for the purpose of Humanitarian Aid and Disaster Relief, or in a situation when there is a need in a cost effective and durable product that can sustain masses of individuals. The foodstuff may be used in prisons as cost efficient food the use of which would also neutralize the use of silverware that has to be monitored to ensure that prisoners do not hurt each other or the security team.

Senior lacking mobility may use the foodstuff in the form of biscuits if they have to provide food for themselves. There are other categories of consumers that may require a satisfying meal replacement, such as foodstuff described herein, to sustain them in their daily activities

The foodstuff may be appealing to college students, recent graduates, and single/busy parents. This group of consumers is more likely than other consumers to either skip meals entirely or substitute proper meals with nutritionally inferior snack foods. The foodstuff in the form of a biscuit, a bar, a cookie, a crisp, a pellet, a patty, a cake, a chip, a cracker, a puffed snack, or extruded snack, brownie, or any other compact, easy to carry, snack-like food that can satisfy the “busy lifestyle” consumers' meal replacement needs in a more nutritionally balanced way. These consumers may also have preference for “clean label” foodstuff described herein. (A. Elizabeth Sloan, 2015, The Top Ten Food Trends, Food Technology, 24-40).

The references cited throughout this application are incorporated for all purposes apparent herein and in the references themselves as if each reference was fully set forth. For the sake of presentation, specific ones of these references are cited at particular locations herein. A citation of a reference at a particular location indicates a manner(s) in which the teachings of the reference are incorporated. However, a citation of a reference at a particular location does not limit the manner in which all of the teachings of the cited reference are incorporated for all purposes.

What is claimed is:

1. A nutritionally-balanced solid foodstuff comprising carbohydrates, one or more plant-derived proteins and lipids in an amount equal to 100% of the Daily Reference Values (DRV) based on the reference caloric intake of 2000 calories, wherein the one or more plant-derived proteins have a Protein Digestibility Corrected Amino Acid Score (PDCAAS) of 0.95 or greater.

2. The nutritionally-balanced solid foodstuff of claim 1, the one or more plant-derived proteins have a Protein Digestibility Corrected Amino Acid Score (PDCAAS) of 1.00.

3. The nutritionally-balanced solid foodstuff of claim 1, wherein the foodstuff comprises the one or more plant-derived proteins in the amount of 10.2% (w/w) to 10.5% (w/w) per 100 kcal of the foodstuff, carbohydrates in the amount of 52.6% (w/w) to 53.98% (w/w) per 100 kcal of the foodstuff, and lipids in the amount of 35.9% (w/w) to 36.9% (w/w/) per 100 kcal of the foodstuff.

4. The nutritionally-balanced solid foodstuff of claim 1, wherein the one or more plant-derived proteins comprise a brown rice protein and a yellow pea protein.

5. The nutritionally-balanced solid foodstuff of claim 1, wherein the carbohydrates are derived from gluten free plant flour.

6. The nutritionally-balanced solid foodstuff of claim 5, wherein the gluten free plant flour is white rice flour or sorghum flour.

7. The nutritionally-balanced solid foodstuff of claim 1, wherein the foodstuff comprises a sweetener derived from a stevia plant.

8. The nutritionally-balanced foodstuff of claim 1, wherein the carbohydrates comprise a dietary fiber.

9. The nutritionally-balanced solid foodstuff of claim 1, wherein lipids comprise plant-derived oil selected from the group consisting of: grapeseed oil, sesame oil, safflower oil and linoleic sunflower oil.

10. The nutritionally nutritionally-balanced solid foodstuff of claim 9, wherein the plant-derived oil comprises grapeseed oil.

11. The nutritionally nutritionally-balanced solid foodstuff of claim 1, wherein the foodstuff comprises a plurality of units, wherein
each unit of the plurality of units represents an exact caloric value of the foodstuff, and
the exact caloric value of the unit equals 5 grams of calories or greater, or 10 grams of calories or lesser per unit of the foodstuff.

12. The nutritionally-balanced foodstuff of claim 11, wherein the unit is a biscuit, a bar, a cookie, a crisp, a pellet, a patty, a cake, a chip, a cracker, a puffed snack, or extruded snack or brownie.

13. The nutritionally-balanced foodstuff of claim 1, wherein the foodstuff has a water activity level of 0.30, or less.

14. A method of manufacturing a nutritionally-balanced solid foodstuff of claim 1 comprising:
selecting components of the foodstuff comprising carbohydrates, one or more plant-derived proteins having PDCAAS of 95 or greater, and lipids;
determining an amount of each one of the components that is equal to 100% of the Daily Reference Values (DRV) for food based on the reference caloric intake of 2000 calories;
preparing dough by combining the food components; and
applying to the dough at least one process selected from the group consisting of: baking, crumbing, injecting with inert gas, and extruding.

15. The method of claim 14, wherein the one or more plant-derived proteins comprise a brown rice protein and a yellow pea protein.

16. The method of claim 14, wherein the carbohydrates comprise gluten free plant flour selected from white rice flour, or sorghum flour

17. The method of claim 14, wherein carbohydrates comprise honey.

18. The method of claim 14, wherein the carbohydrates comprise dietary fiber.

19. The method of claim 14, wherein the lipids comprise plant-derived oil.

20. The method of claim 14, wherein prior to the step of applying comprising reconstituting the foodstuff into a plurality of units, wherein each unit of the plurality of units represents an exact caloric value of the foodstuff;
wherein the exact caloric value of the unit equals 5 grams of calories or greater, or 10 grams of calories or lesser per unit of the foodstuff.

21. The method of claim 14, wherein the method further comprises dehydrating the foodstuff, such that the foodstuff has a water activity level of 0.30, or less.
